(19) United States
(12) Patent Application Publication
(10) Pub. No.: US 2015/0148970 A1
(43) Pub. Date: May 28, 2015

(54) SYSTEM AND METHOD FOR ENABLING WIRELESS COMMUNICATION WITH A MOTOR CONTROLLER

(71) Applicant: Regal Beloit America, Inc., Beloit, WI (US)

(72) Inventors: Yilcan Guzelgunler, Troy, OH (US); Jason Jon Kreidler, Sheboygan Falls, WI (US); William Edward Young, Grafton, WI (US); Marc C. McKinzie, West Milton, OH (US); Mitchell T. Kiser, Piqua, OH (US); Alan M. Smith, Beavercreek, OH (US)

(73) Assignee: Regal Beloit America, Inc., Beloit, WI (US)

(21) Appl. No.: 14/089,174

(22) Filed: Nov. 25, 2013

(51) Int. Cl. G05D 7/06

(52) U.S. Cl. CPC G05D 7/0617
USPC 700/282; 455/420

(57) ABSTRACT

A motor controller coupled to a motor is described. The motor controller includes a wireless communication device and a computing device coupled to the wireless communication device. The computing device is configured to communicatively couple with a client computing device using the wireless communication device, wirelessly receive at least one setting from the client computing device, and operate the motor pursuant to the at least one setting, to move liquid in an aquatic environment.

### BACKGROUND

The field of the disclosure relates generally to motors, and more particularly, to systems and methods for enabling wireless communication with a motor controller.

At least some known systems used in fluid moving applications, such as pumping water or moving air (e.g., in a heating, ventilation, and air conditioning (HVAC) system) include a motor, for example a variable speed electric motor, coupled to a motor controller. Generally, a physical user interface is coupled to the motor controller to enable a user to view a status of the motor and/or to enter operating parameters for the motor. Other known systems include an automation controller that is physically connected to a motor controller, for example by a networking cable, and to other devices, such as lights, heaters, a chlorine generator, auxiliary pumps, valves, etc. Such automation controllers may be configured to communicate wirelessly with a computing device, such as a laptop or cellular phone (e.g., a smart phone), to present an application that enables a user to view a status of one or more devices controlled by the automation controller and to enter operating parameters for the one or more devices. However, including a physical user interface with a motor controller or adding an automation controller to act as a bridge between a motor controller and an application presented on a portable computing device has an associated cost.

### BRIEF DESCRIPTION

In one aspect, a motor controller coupled to a motor is provided. The motor controller includes a wireless communication device and a computing device coupled to the wireless communication device. The computing device is configured to communicatively couple with a client computing device using the wireless communication device, wirelessly receive at least one setting from the client computing device, and operate the motor pursuant to the at least one setting, to move liquid in an aquatic environment.

In another aspect, a method for enabling wireless communication with a motor controller is provided. The motor controller includes a wireless communication device and a computing device coupled to the wireless communication device is provided. The method includes communicatively coupling the computing device with a client computing device using the wireless communication device, wirelessly receiving, by the computing device, at least one setting from the client computing device, and operating the motor, by the computing device, pursuant to the at least one setting, to move liquid in an aquatic environment.

In another aspect, a computer-readable storage device having processor-executable instructions embodied thereon is provided. The processor-executable instructions enable wireless communication with a motor controller including a wireless communication device and a computing device coupled to the wireless communication device. When executed by the computing device, the processor-executable instructions cause the computing device to communicatively couple with a client computing device using the wireless communication device, wirelessly receive at least one setting from the client computing device, and operate the motor pursuant to the at least one setting, to move liquid in an aquatic environment.

### BRIEF DESCRIPTION OF THE DRAWINGS

FIG. 1 is a block diagram of an example system including a motor controller that is coupled to a motor that drives a pump.

FIG. 2 is a block diagram of an example computing device that may be incorporated in the motor controller of FIG. 1.

FIG. 3 is a block diagram of a first example system in which the motor controller of FIG. 1 wirelessly communicates with a plurality of client computing devices.

FIG. 4 is a block diagram of an example application that may be presented on a client computing device.

FIG. 5 is a block diagram of a second example system in which the motor controller of FIG. 1 wirelessly communicates with a plurality of client computing devices through a cellular network.

FIG. 6 is a block diagram of a third example system in which the motor controller of FIG. 1 wirelessly communicates with a plurality of client computing devices through a wireless local area network.

FIG. 7 is a block diagram of a fourth example system in which the motor controller of FIG. 1 wirelessly communicates with a plurality of client computing devices through a combination of wireless local area networks and the Internet.

FIG. 8 is a block diagram of a fifth example system in which the motor controller of FIG. 1 wirelessly communicates with a plurality of client computing devices directly and through a cellular network.

FIG. 9 is a block diagram of a sixth example system in which the motor controller of FIG. 1 wirelessly communicates with a plurality of client computing devices through a wireless local area network and through a cellular network.

FIG. 10 is a block diagram of a seventh example system in which the motor controller of FIG. 1 wirelessly communicates with a plurality of client computing devices through a combination of wireless local area networks and the Internet.

FIG. 11 is a block diagram of an eighth example system in which the motor controller of FIG. 1 wirelessly communicates with a plurality of client computing devices through a combination of wireless local area networks, a cellular network, and the Internet.

FIG. 12 is a flow chart of an example process for enabling wireless communication with a motor controller in accordance with one aspect of the present disclosure.

### DETAILED DESCRIPTION

Implementations of the systems and methods described herein enable a motor controller to wirelessly communicate with a client computing device that presents a software application (“application”) for controlling and viewing status information regarding the motor controller. Accordingly, the need for a physical user interface coupled to the motor controller, or an automation controller wired to the motor controller, is eliminated. More specifically, the motor controller includes a wireless communication device coupled to a computing device. The wireless communication device enables the computing device to wirelessly transmit data to and receive data from at least one client computing device. The client computing device presents an application to a user of the client computing device, for example through a touchscreen, to enable the user to view a status and/or operating parameters transmitted from the computing device in the motor controller, and to transmit data, including operating parameters, to the computing device in the motor controller. In some implementations, data is transmitted wirelessly directly between the motor controller and the client computing device. In other implementations, data is transmitted through one or more of a wireless local area network, a cellular network, and the Internet.

In one implementation, a computer program is provided, and the program is embodied on a computer-readable medium. In an example implementation, the computer program is executed on a single computing device, without requiring a connection to a server computer. The computer program is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

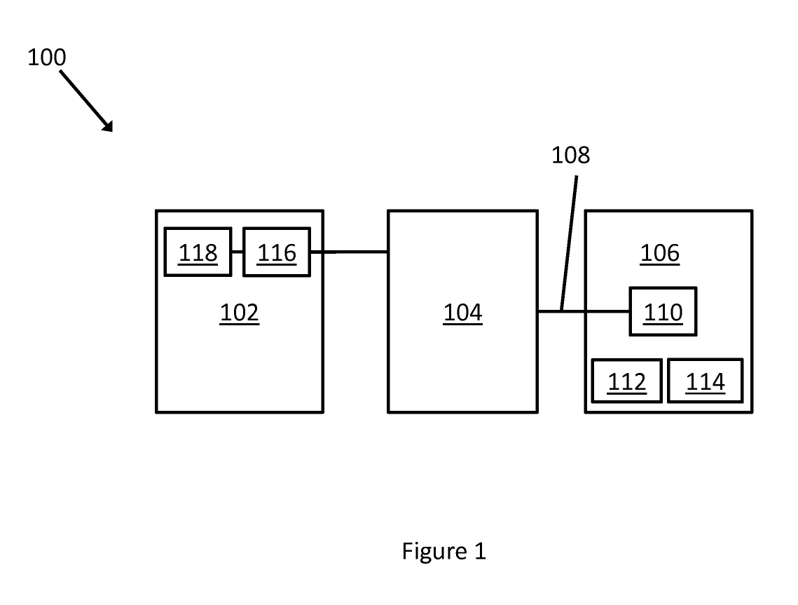

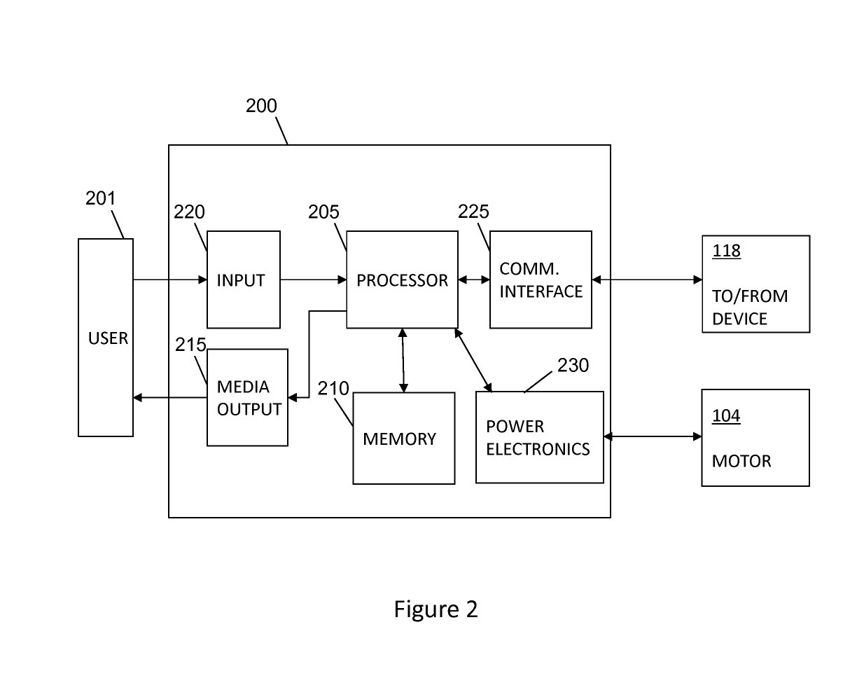

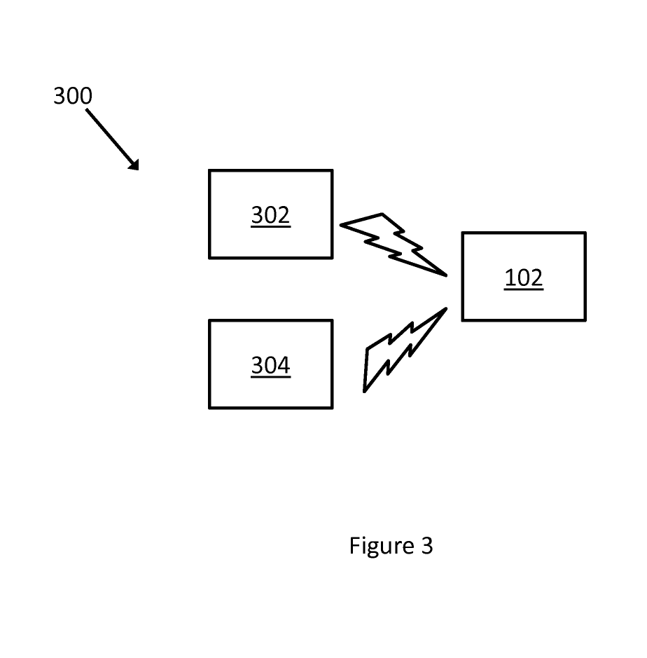

FIG. 1 is a block diagram of an example system 100 that includes a motor controller 102 coupled to a motor 104. In some implementations, motor controller 102 is incorporated within motor 104. Motor 104 may be an electric motor and, in some implementations, is an electric variable speed motor. Motor 104 drives a pump 106. More specifically, motor 104 is coupled to pump 106 by a shaft 108. Shaft 108 rotates to turn an impeller 110. Pump 106 includes an inlet 112 and an outlet 114. In some implementations, system 100 is used to move liquid, such as water, in a pool, spa, or other aquatic environment. In such implementations, inlet 112 receives the water and outlet 114 expels the received water. In other implementations, motor 104 drives a fan for moving air, for example in a heating, ventilation, and air conditioning (HVAC) system. Motor controller 102 includes a computing device 116 and a wireless communication device 118. Motor controller 102 is configured to operate motor 104 according to settings stored in a memory 210 (FIG. 2) of computing device 116. The settings may include modes of operation, wherein each mode is associated with a time period and a speed. For example, one mode may be to operate motor 104 at 2100 rotations per minute (RPM) from 1:00 PM to 6:00 PM. One or more other modes may be based on sensing water chemistry and/or water clarity. In other implementations, the time period is specified as a duration, such as five hours, rather than as an absolute start time and absolute stop time. Wireless communication device 118 is coupled to computing device 116. As described herein, wireless communication device 118 enables computing device 116 to wirelessly communicate with at least one client computing device 302 (FIG. 3).

FIG. 2 is a block diagram of an example computing device 200 that may be incorporated in motor controller 102 (FIG. 1). For example, computing device 116 may include components of computing device 200. Computing device 200 includes a processor 205 for executing instructions. In some implementations, executable instructions are stored in a memory area 210. Processor 205 may include one or more processing units (e.g., in a multi-core configuration). Memory area 210 is any device allowing information such as executable instructions and/or other data to be stored and retrieved. With respect to computing device 116, memory area 210 stores executable instructions for communicating with at least one client computing device 302 (FIG. 3) using wireless communication device 118 (FIG. 1). Additionally, memory area 210 stores settings for operating motor 104, as described herein. Memory area 210 may include one or more computer-readable media.

In some implementations, computing device 200 also includes at least one media output component 215 for presenting information to user 201. Media output component 215 is any component capable of conveying information to user 201. In some implementations, media output component 215 includes an output adapter such as a video adapter and/or an audio adapter. An output adapter is operatively coupled to processor 205 and operatively couplable to an output device such as a display device (e.g., a liquid crystal display (LCD), one or more light emitting diodes (LED), an organic light emitting diode (OLED) display, cathode ray tube (CRT), or “electronic ink” display) or an audio output device (e.g., a speaker or headphones). In other implementations, computing device 200 does not include media output component 215. For example, some implementations of computing device 116 (FIG. 1) may not include media output component 215.

In some implementations, computing device 200 includes an input device 220 for receiving input from user 201. Input device 220 may include, for example, one or more buttons, a keypad, a touch sensitive panel (e.g., a touch pad or a touch screen), and/or a microphone. A single component such as a touch screen may function as both an output device of media output component 215 and input device 220. Some implementations of computing device 200, for example some implementations of computing device 116 (FIG. 1), do not include input device 220.

Computing device 200 may also include a communication interface 225, which is communicatively couplable to another device. For example, communication interface 225 may include or be coupled to wireless communication device 118 (FIG. 1) to enable wireless communication with at least one client computing device 302 (FIG. 3) for example through a short range wireless communication protocol such as Bluetooth™ or Z-Wave™, through a wireless local area network (WLAN) implemented pursuant to an IEEE (Institute of Electrical and Electronics Engineers) 802.11 standard (i.e., WiFi), and/or through a mobile phone (i.e., cellular) network (e.g., Global System for Mobile communications (GSM), 3G, 4G) or other mobile data network (e.g., Worldwide Interoperability for Microwave Access (WIMAX)). In some implementations, communication interface 225 is directly capable of enabling such wireless communications. For example, in some implementations, communication interface 225 includes a wireless communication device, such as wireless communication device 118 (FIG. 1). Additionally, communication interface 225 may couple motor controller 102 to motor 104. In such implementations, communication interface 225 may include, for example, one or more conductors for transmitting electrical signals and/or power to and/or from motor 104. Additionally, computing device 200 may also include power electronics 230 which may be coupled, for example, to processor 205 and motor 104.

FIG. 3 is a block diagram of a first example system 300 in which motor controller 102 wirelessly communicates with a first client computing device 302 and a second client computing device 304. First client computing device 302 and second client computing device 304 may be similar to computing device 200 (FIG. 2). First client computing device 302 may be, for example, a portable tablet computing device with a touchscreen, and second client computing device 304 may be, for example, a cellular phone (e.g., a smartphone). More specifically, motor controller 102 transmits and receives data and instructions to and from first client computing device 302 and second client computing device 304. For example, wireless communication device 118 (FIG. 1) of motor controller 102 is configured to communicate with first computing device 302 and second computing device 304 using a short-range wireless communication protocol, for example Bluetooth™. In some implementations, in establishing wireless communication (i.e., communicatively coupling) with at least one of first computing device 302 and second computing device 304, motor controller 102 acts as a master device in a piconet. In other implementations, motor controller 102 acts as a slave device in a piconet, while one of first client computing device 302, second client computing device 304, or another device (not shown), acts as a master device. In other implementations, communication between motor controller 102 and one or more of first client computing device 302 and second client computing device 304 may take place using one or more other wireless communication protocols over any range. In some implementations, motor controller 102 wirelessly communicates with first client computing device 302 using a first protocol over a first range, and motor controller 102 wirelessly communicates with second client computing device 304 using a second protocol over a second range, wherein the first protocol is different than the second protocol and/or the first range is different than the second range.

If wireless communication between motor controller 102 and one or more of first client computing device 302 and second client computing device 304 ends, motor controller 102 continues to operate pursuant to settings (e.g., operating parameters) stored in memory 210. For example, if motor controller 102 receives settings from first client computing device 302 to operate motor 104 at a first speed of 1000 rotations per minute (RPM) for a first time period, for example 8:00 AM to 4:00 PM, motor controller 102 stores the received settings in memory 210. Thereafter, motor controller 102 operates motor 104 pursuant to the received settings, regardless of whether first client computing device 302 or second client computing device 304 remains communicatively coupled to motor controller 102.

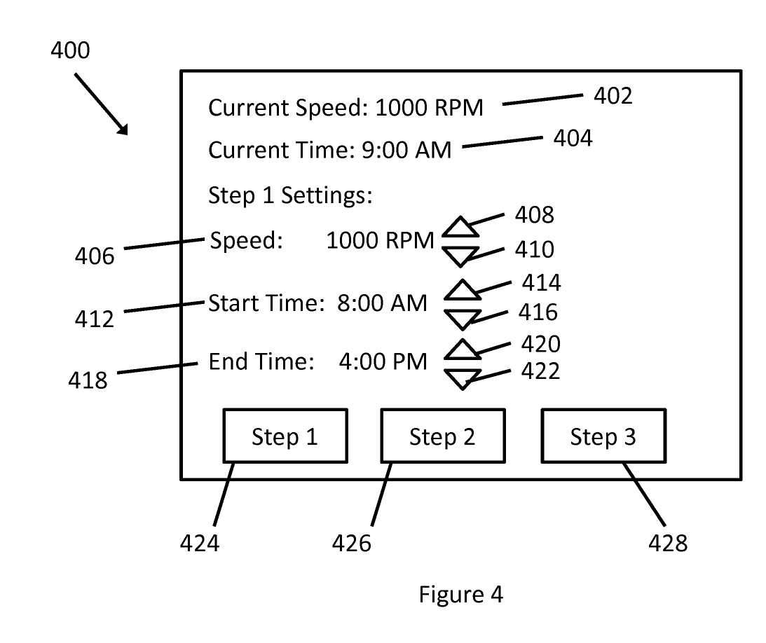

FIG. 4 is a block diagram of an example application 400 that may be presented on a client computing device, for example first client computing device 302 (FIG. 3). More specifically, first client computing device 302 may execute a thin client, such as a web browser, that is configured to render text and images from source code, for example HTML (hyper-text markup language) and/or JavaScript, transmitted from motor controller 102 to first client computing device 302. In other implementations, first client computing device 302 may execute a rich client, such as a software program that is stored in memory area 210 of client computing device 302 and that is specifically configured to communicate with motor controller 102. First client computing device 302 presents (i.e., displays) application 400 to a user, for example user 201 (FIG. 2), using media output component 215 (FIG. 2). Application 400 displays status data transmitted from motor controller 102. For example, application 400 displays a current speed indicator 402 and a current time indicator 404. Current speed indicator 402 displays a current speed of motor 104, based on current speed data transmitted from motor controller 102.

In addition, application 400 displays a target speed indicator 406, a first increase button 408, and a first decrease button 410. Additionally, application 400 displays a start time indicator 412, a second increase button 414, and a second decrease button 416. Application 400 also displays an end time indicator 418, a third increase button 420, and a third decrease button 422. Additionally, application 400 displays a first step button 424, a second step button 426, and a third step button 428. More specifically, motor controller 102 may operate motor 104 in a plurality of modes or steps during a cyclic time period, such as a 24-hour cycle. In a first step, motor controller 102 may operate motor 104 at a target speed, indicated by target speed indicator 406, between a first start time, indicated by start time indicator 412, and a first end time, indicated by end time indicator 418. If first client computing device 302 determines that first increase button 408 has been activated, for example by user 201 tapping or touching first increase button, first client computing device 302 increases target speed indicator 406 by a predetermined value, such as 1 RPM, 5 RPM, or 10 RPM. Likewise, if first client computing device 302 determines that first decrease button 410 has been activated, first client computing device 302 decreases target speed indicator 406 by a predetermined value, such as 1 RPM, 5 RPM, or 10 RPM. Additionally, first client computing device 302 detects when second increase button 414, second decrease button 416, third increase button 420, and third decrease button 422 have been activated and increases or decreases start time indicator 412 and/or end time indicator 418 accordingly.

When first client computing device 302 detects that one of first step button 424, second step button 426, and third step button 428 has been activated, first client computing device 302 causes application 400 to display the corresponding target speed, start time, and end time using target speed indicator 406, start time indicator 412, and end time indicator 418. More specifically, in some implementations, first client computing device 302 transmits an instruction to motor controller 102 to transmit settings associated with the selected step to first client computing device 302. Subsequently, motor controller 102 transmits the settings associated with the selected step to first client computing device 302. After receiving the settings transmitted from motor controller 102, first client computing device 302 displays the settings as described above.

Additionally, first client computing device 302 transmits settings (operating parameters) associated with first step, second step, and third step to motor controller 102. For example, each time first increase button 408, first decrease button 410, second increase button 414, second decrease button 416, third increase button 420, or third decrease button 422 is activated, first client computing device 302 may transmit the corresponding target speed value, start time, or end time to motor controller 102 in association with a selected one of the first step, the second step, and the third step. In other implementations, first client computing device 302 may transmit the settings associated with one step to motor controller 102 prior to displaying settings associated with another step. In other implementations, first client computing device 302 transmits settings to motor controller 102 upon the occurrence of a different event, or on a periodic basis. In other implementations, motor controller 102 may be configured to operate pursuant a different number of steps than three. While the above description uses first client computing device 302 as an example, it should be understood that second client computing device 304 operates and communicates with motor controller 102 in a similar manner. In other implementations, application 400 may include more or fewer features than those described above. For example, in some implementations, application 400 may include additional features pertaining to modes of operation or cycles based on other inputs, such as temperatures, chemical testing, energy cost, etc.

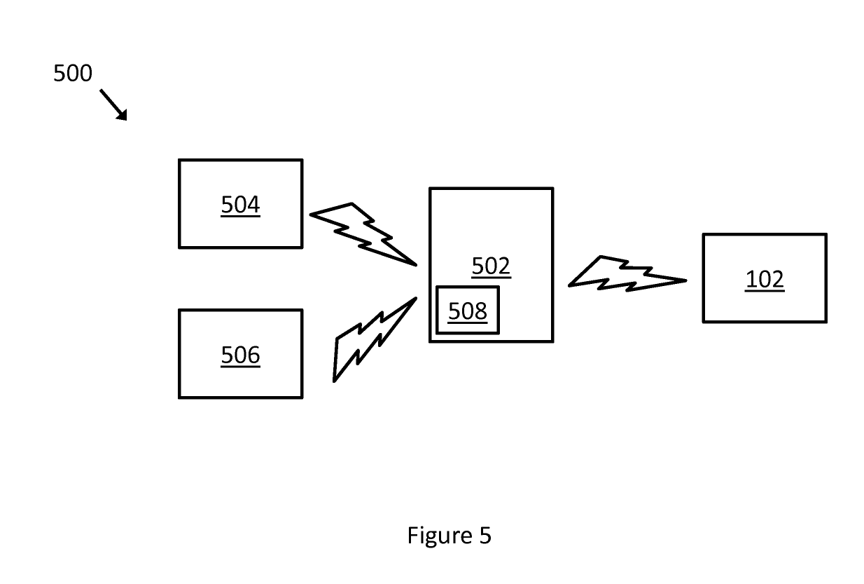

FIG. 5 is a block diagram of a second example system 500 in which the motor controller 102 wirelessly communicates with a first client computing device 504 and a second client computing device 506 through a cellular network 502. First client computing device 504 may be similar to first client computing device 302 (FIG. 3) and second client computing device 506 may be similar to second client computing device 304 (FIG. 3). Wireless communication device 118 (FIG. 1) of motor controller 102 is configured to transmit and receive data and instructions over cellular network 502. In some implementations, motor controller 102 and more specifically, wireless communication device 118 (FIG. 1), is assigned a phone number. Cellular network 502 may include a cellular tower 508 that routes transmissions of data and instructions between motor controller 102, first client computing device 504, and second client computing device 506. Accordingly, first client computing device 504 and/or second client computing device 506 may be located remotely from motor controller 102 and still transmit and receive data and/or instructions with motor controller 102. That is, the description of communication between motor controller 102 and first client computing device 302 (FIG. 3) applies equally with respect to communication between motor controller 102 and first client computing device 504, as well as between motor controller 102 and second client computing device 506. In some implementations, one or more of motor controller 102 and client computing devices 504 and 506 may communicate with a utility provider (not shown), for example through cellular network 502, to limit energy usage of motor 104 based on, for example, energy pricing information transmitted from the utility provider.

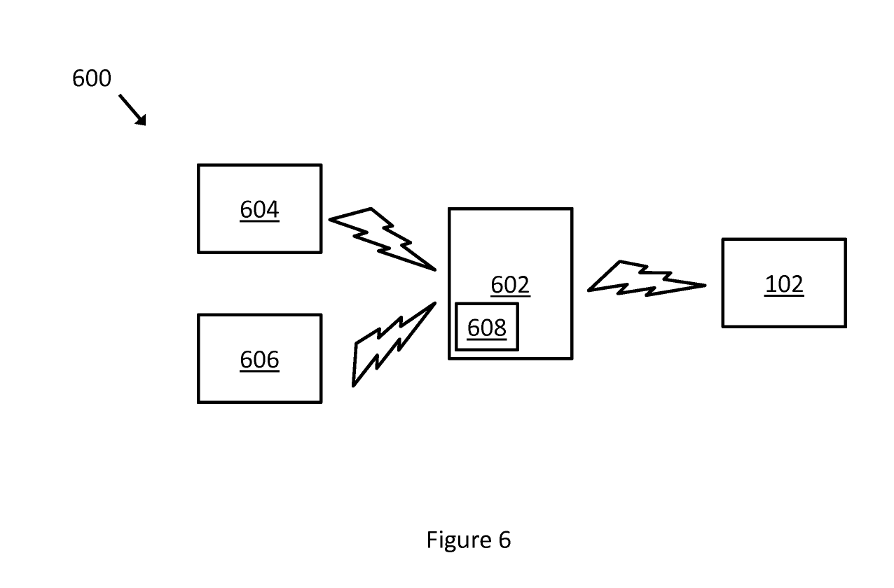

FIG. 6 is a block diagram of a third example system 600 in which motor controller 102 wirelessly communicates with a first client computing device 604 and a second client computing device 606 through a wireless local area network 602. First client computing device 604 may be similar to first client computing device 302 (FIG. 3) and second client computing device 606 may be similar to second client computing device 304 (FIG. 3). Wireless communication device 118 (FIG. 1) of motor controller 102 is configured to transmit and receive data and instructions over wireless local area network 602. For example, wireless communication device 118 may be configured to transmit and receive data and instructions using an IEEE 802.11 wireless communication protocol. Wireless local area network 602 may include a wireless router 608 that routes transmissions of data and instructions between motor controller 102, first client computing device 604, and second client computing device 606. The description of communication between motor controller 102 and first client computing device 302 applies equally with respect to communication between motor controller 102 and first client computing device 604, as well as between motor controller 102 and second client computing device 606.

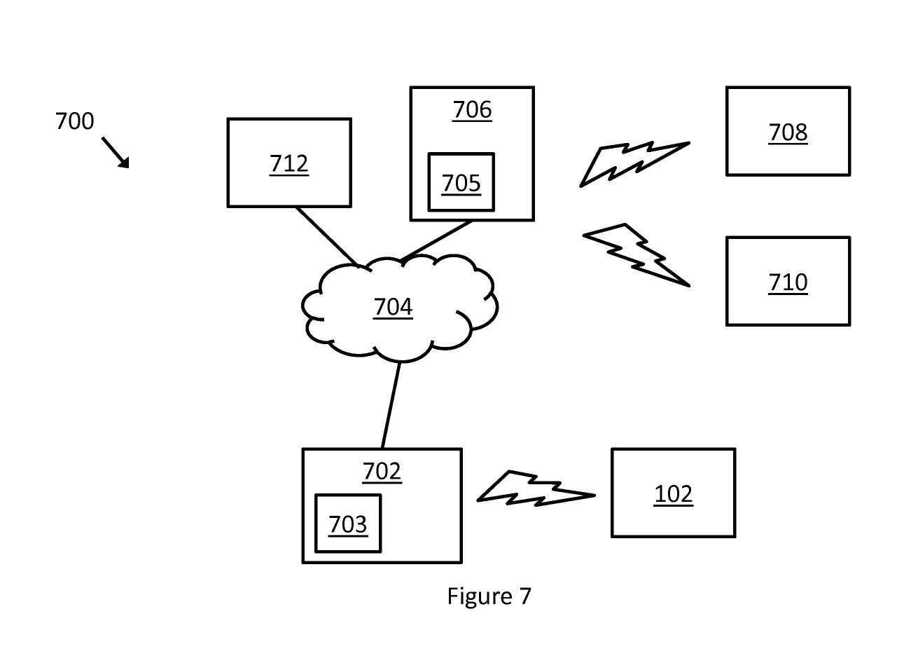

FIG. 7 is a block diagram of a fourth example system 700 in which motor controller 102 wirelessly communicates with a first client computing device 708, a second client computing device 710, and a third client computing device 712 through a combination of wireless local area networks and the Internet 704. First client computing device 708 may be similar to first client computing device 302 (FIG. 3) and second client computing device 710 may be similar to second client computing device (FIG. 3). Third client computing device 712 may be wired to Internet 704 through one or more networking devices (not shown) and may be, for example a desktop computing device. Third client computing device 712 is otherwise similar to first client computing device 708 and second client computing device 710. Motor controller 102 wirelessly communicates through a first wireless local area network 702. More specifically, motor controller 102 wirelessly communicates through first wireless router 703, using for example, an IEEE 802.11 wireless communication protocol. First wireless router 703 is coupled to Internet 704. Internet 704 routes data and instructions to and from first client computing device 708, second client computing device 710, and third client computing device 712. More specifically, first client computing device 708 and second client computing device 710 wirelessly communicate through a second wireless local area network 706 using second wireless router 705. Accordingly, in system 700, first client computing device 708, second client computing device 710, and/or third client computing device 712 may be located remotely from motor controller 102 and still transmit and receive data and/or instructions with motor controller 102 as described above with reference to system 300.

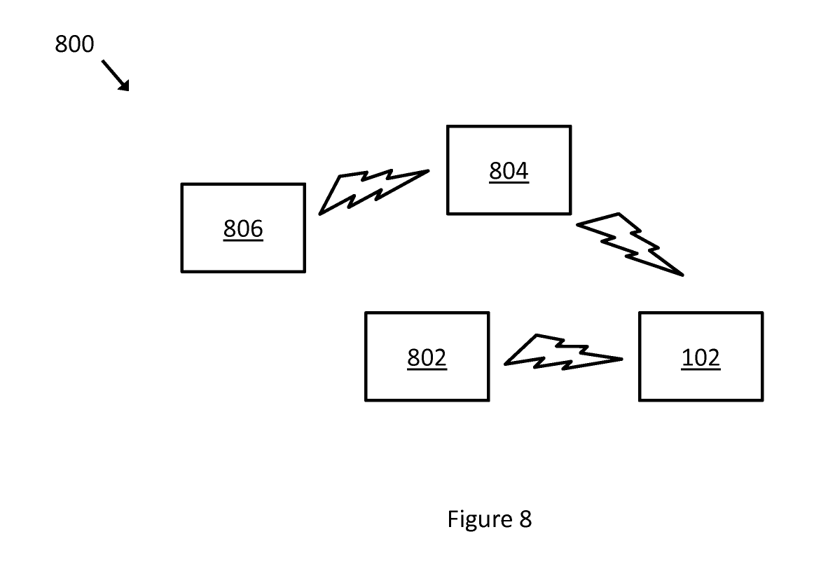

FIG. 8 is a block diagram of a fifth example system 800 in which motor controller 102 wirelessly communicates with a first client computing device 802 and a second client computing device 806. More specifically, wireless communication device 118 (FIG. 1) of motor controller 102 is configured to communicate with first client computing device 802 using a short-range wireless communication protocol, such as Bluetooth™, and to communicate with second client computing device 806 through a cellular network 804 using a second wireless communication protocol that is adapted for use with a cellular network (e.g., Global System for Mobile communications (GSM), 3G, 4G) or other mobile data network (e.g., Worldwide Interoperability for Microwave Access (WIMAX)). First client computing device 802 may be similar to first client computing device 302 (FIG. 3) and second client computing device 806 may be similar to second client computing device 304 (FIG. 3). The above descriptions of wireless communication with motor controller 102 apply equally to system 800.

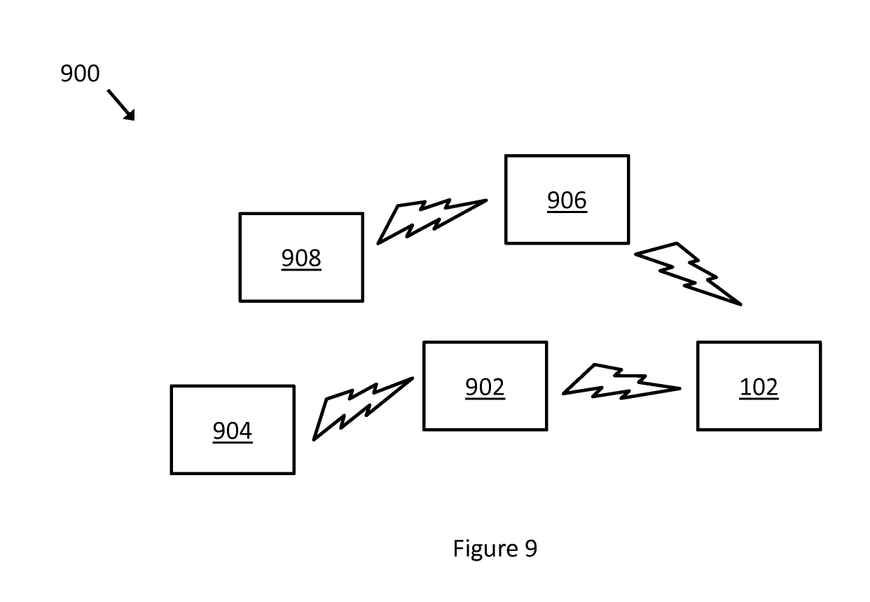

FIG. 9 is a block diagram of a sixth example system 900 in which motor controller 102 wirelessly communicates with a first client computing device 904 and a second client computing device 908. More specifically, motor controller 102 communicates with first client computing device 904 through a wireless local area network 902 and motor controller 102 communicates with second client computing device 908 through a cellular network 906. The above descriptions of wireless communication with motor controller 102 apply equally to system 900.

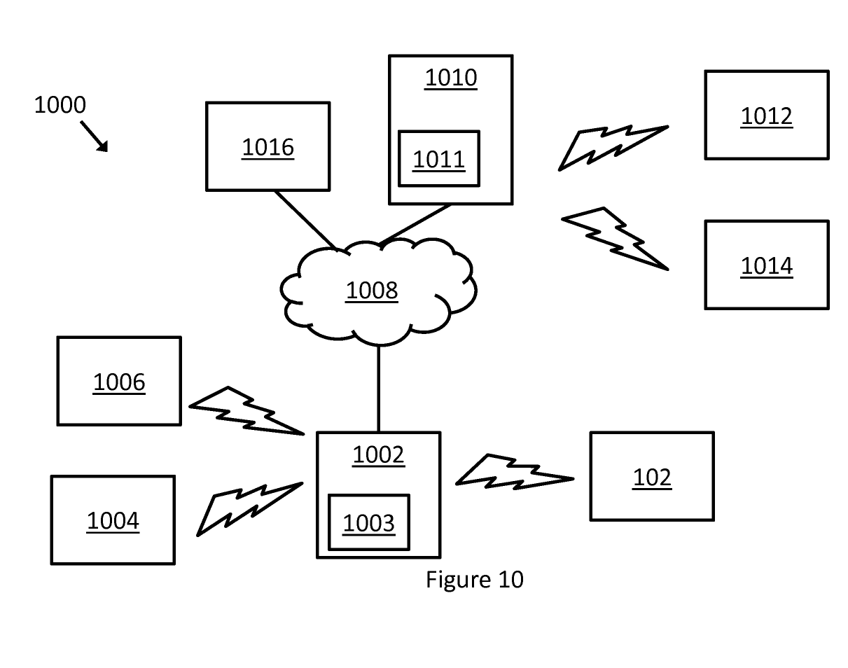

FIG. 10 is a block diagram of a seventh example system 1000 in which motor controller 102 wirelessly communicates with a first client computing device 1004, a second client computing device 1006, a third client computing device 1012, a fourth client computing device 1014, and a fifth client computing device 1016. More specifically, motor controller 102 wirelessly communicates with first client computing device 1004 and second client computing device 1006 through a first wireless local area network 1002 that includes a first wireless router 1003 similar to first wireless router 703 (FIG. 7). Wireless router 1003 is coupled to the Internet 1008. Internet 1008 routes data and instructions between first wireless network 1002 and third client computing device 1012, fourth client computing device 1014, and fifth client computing device 1016. More specifically, third client computing device 1012 and fourth client computing device 1014 wirelessly communicate through a second wireless local area network 1010 using a second wireless router 1011 which is coupled to Internet 1008. Third client computing device 1012 and fourth client computing device 1014 are similar to first client computing device 708 (FIG. 7) and second client computing device 710 (FIG. 7). Fifth client computing device 1016 is similar to third client computing device 712 (FIG. 7) in that fifth client computing device 1016 is physically coupled to Internet 1008. The above descriptions of wireless communication with motor controller 102 apply equally to system 1000.

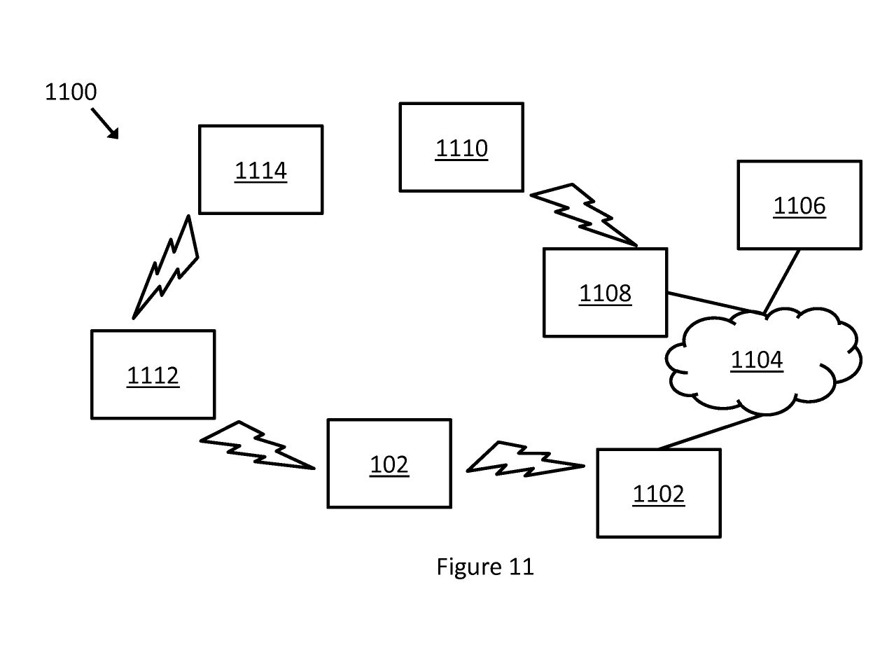

FIG. 11 is a block diagram of an eighth example system 1100 in which motor controller 102 wirelessly communicates with a plurality of client computing devices, including a first client computing device 1106, a second client computing device 1110, and a third client computing device 1114. System 1100 includes wireless local area network 1102 which couples motor controller 102 to the Internet 1104. Internet 1104 routes data and instructions to and from wireless local area network 1108 and first client computing device 1106. Second client computing device 1110 is wirelessly coupled to wireless local area network 1108, which couples second client computing device 1110 to Internet 1104. Motor controller 102 wirelessly communicates with third client computing device 1114 through cellular network 1112. First client computing device 1106, second client computing device 1110, and third client computing device 1114 are similar to client computing devices described above, for example first client computing device 302 (FIG. 3). Accordingly, the above descriptions of wireless communication with motor controller 102 apply equally to system 1100.

In some implementations, motor controller 102 may generate and transmit data, such as a status, a change in status, a fault message, a fault code, and/or other report to a client computing device in an email and/or in a text message. For example, third client computing device 1114 may receive a text message from motor controller stating that the speed of motor 104 has changed from a first speed to a second speed. Additionally or alternatively, third client computing device 1114 may receive an email from motor controller 102 indicating that the speed of motor 104 has changed from the first speed to the second speed. In some implementations, motor controller 102 may receive data and/or instructions from one or more client computing devices through one or more emails or text messages. For example, third client computing device 1114 may transmit an email or text message to motor controller 102 to increase or decrease the speed of motor 104. Additionally, in some implementations, in establishing wireless communication with a client computing device (e.g., third client computing device 1114), computing device 116 may require user 201 of third client computing device 1114 to enter authentication credentials or a certificate (e.g., a user name and password or Public Key Infrastructure (PKI) certificate). In some implementations, motor controller 102 is configured with additional features and software that protects against unwanted access. In some implementations, emails and/or text messages such as those described above may be transmitted through the Internet, and in some implementations, such email and/or text messages may be provided through a cloud service.

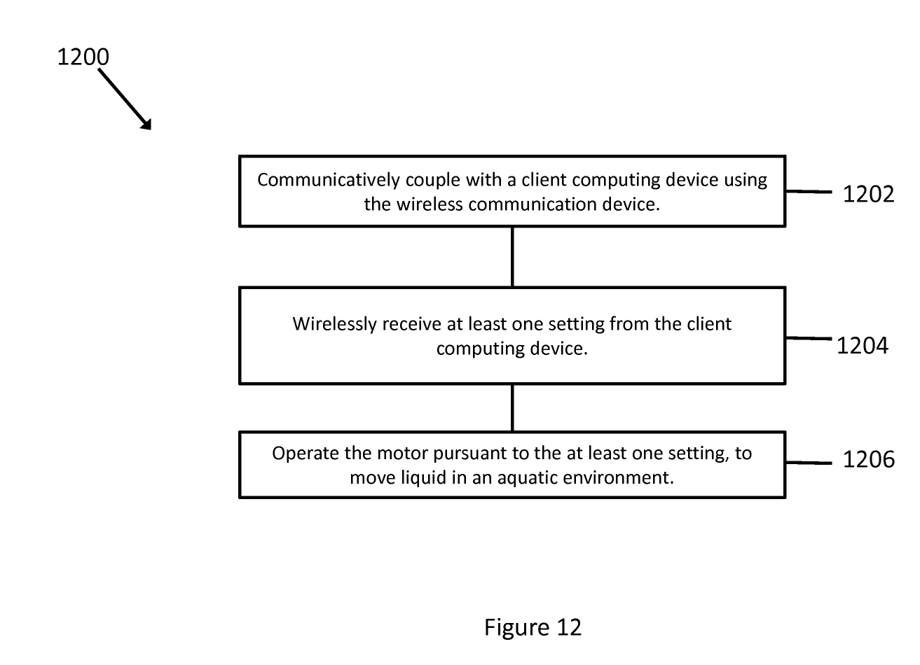

FIG. 12 is a flow chart of an example process 1200 for enabling wireless communication between motor controller 102 (FIG. 1) and at least one client computing device (e.g., first client computing device 302) (FIG. 3). Process 1200 may be performed by motor controller 102. More specifically, process 1200 may be performed by computing device 116 (FIG. 1) of motor controller 102. Initially, computing device 116 communicatively couples 1202 with client computing device 302 using wireless communication device 118 (FIG. 1). For example, computing device 116 may establish communication with client computing device 302 using a short-range wireless communication (e.g., Bluetooth™), or through a wireless local area network or cellular network, as described above. Additionally, computing device 116 wirelessly receives 1204 at least one setting from client computing device 302. For example, computing device 116 may receive a target speed, a begin time, and/or an end time associated with a mode or step of operation of motor controller 102 and motor 104 (FIG. 1). Additionally, computing device 116 operates 1206 motor 104 (FIG. 1) pursuant to the at least one setting, to move liquid in an aquatic environment such as a pool or spa. For example, computing device 116 of motor controller 102 may cause motor 104 to operate at the target speed for a time period beginning at the begin time and ending at the end time, as described above.

The methods and systems described herein may be implemented using computer programming or engineering techniques including computer software, firmware, hardware or any combination or subset thereof, wherein the technical effect may include at least one of: (a) communicatively coupling with a client computing device using a wireless communication device; (b) wirelessly receiving at least one setting from the client computing device; and (c) operating a motor pursuant to the at least one setting.

While above methods and systems have been described in connection with a motor controller, the principals of the methods and systems described herein may be applied to enable wireless communication with other devices such as chlorinators, pool covers, pool lights, etc.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205, including RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

As compared to known systems and methods for communicating with a motor controller, the systems and methods described herein enable a motor controller to wirelessly communicate with at least one client computing device that presents a software application to a user for controlling and communicating with the motor controller. Accordingly, the motor controller does not need to be physically coupled to a user interface or an automation controller in order to receive and transmit data and instructions.

Exemplary embodiments of systems and methods for enabling wireless communication with a motor controller are described herein. The systems and methods described herein are not limited to the specific embodiments described herein, but rather, components of the systems and/or steps of the methods may be utilized independently and separately from other components and/or steps described herein.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A motor controller coupled to a motor, said motor controller comprising:
a wireless communication device; and
a computing device coupled to said wireless communication device, wherein said computing device is configured to:
communicatively couple with a client computing device using said wireless communication device;
wirelessly receive at least one setting from the client computing device; and
operate the motor pursuant to the at least one setting, to move liquid in an aquatic environment.

2. The motor controller of claim 1, wherein said computing device is further configured to operate the motor pursuant to the at least one setting while said computing device is not communicatively coupled to the client computing device.

3. The motor controller of claim 1, wherein said computing device is further configured to transmit data to the client computing device for displaying on an application on the client computing device.

4. The motor controller of claim 1, wherein said computing device is further configured to receive authentication credentials or a certificate from the client computing device.

5. The motor controller of claim 1, wherein said computing device is further configured to communicatively couple with the client computing device by communicatively coupling with the client computing device using a wireless local area network.

6. The motor controller of claim 1, wherein said computing device is further configured to communicatively couple with the client computing device by communicatively coupling with the client computing device using a cellular network.

7. The motor controller of claim 1, wherein said computing device is further configured to at least one of:
transmit at least one of a text message and an email to the client computing device using at least one of a cellular network, the Internet, and a cloud service, and
receive at least one of a text message and an email from the client computing device using at least one of a cellular network, the Internet, and a cloud service.

8. The motor controller of claim 7, wherein said computing device is further configured such that transmitting the at least one of the text message and the email further comprises including at least one of a fault message and an indication of a change in operation of the motor in the at least one of the text message and the email.

9. The motor controller of claim 1, wherein said computing device is further configured to generate and transmit at least one of a text message, an email, and a report to the client computing device.

10. A method for enabling wireless communication with a motor controller including a wireless communication device and a computing device coupled to the wireless communication device, said method comprising:
communicatively coupling the computing device with a client computing device using the wireless communication device;
wirelessly receiving, by the computing device, at least one setting from the client computing device; and
operating the motor, by the computing device, pursuant to the at least one setting, to move liquid in an aquatic environment.

11. The method of claim 10, wherein said operating the motor pursuant to the at least one setting further comprises operating the motor pursuant to the at least one setting while the computing device is not communicatively coupled to the client computing device.

12. The method of claim 10, further comprising transmitting data to the client computing device for displaying on an application on the client computing device.

13. The method of claim 10, further comprising receiving authentication credentials or a certificate from the client computing device.

14. The method of claim 10, wherein said communicatively coupling the computing device with the client computing device further comprises communicatively coupling the computing device with the client computing device using a wireless local area network.

15. The method of claim 10, wherein said communicatively coupling the computing device with the client computing device further comprises communicatively coupling the computing device with the client computing device using a cellular network.

16. The method of claim 10, further comprising at least one of:
transmitting at least one of a text message and an email to the client computing device using at least one of a cellular network, the Internet, and a cloud service, and
receiving at least one of a text message and an email from the client computing device using at least one of a cellular network, the Internet, and a cloud service.

17. The method of claim 16, wherein transmitting the at least one of the text message and the email further comprises including at least one of a fault message and an indication of a change in operation of the motor in the at least one of the text message and the email.

18. The method of claim 10, further comprising generating and transmitting at least one of a text message, an email, and a report to the client computing device.

19. A computer-readable storage device having processor-executable instructions embodied thereon, enabling wireless communication with a motor controller including a wireless communication device and a computing device coupled to the wireless communication device, wherein when executed by the computing device, the processor-executable instructions cause the computing device to:
communicatively couple with a client computing device using the wireless communication device;
wirelessly receive at least one setting from the client computing device; and
operate the motor pursuant to the at least one setting, to move liquid in an aquatic environment.

20. The computer-readable storage device of claim 19, wherein said processor-executable instructions further cause the computing device operate the motor pursuant to the at least one setting while the computing device is not communicatively coupled to the client computing device.
